(19) United States
(12) Patent Application Publication
(10) Pub. No.: US 2017/0002550 A1
(43) Pub. Date: Jan. 5, 2017

(54) GATE VALVE DOWNSPOUT DIVERTER FOR RAINWATER COLLECTION

(71) Applicant: Loren Johnson, Friday Harbor, WA (US)

(72) Inventor: Loren Johnson, Friday Harbor, WA (US)

(21) Appl. No.: 14/791,136

(22) Filed: Jul. 2, 2015

(51) Int. Cl. E03B 1/04; F16K 11/02

(52) U.S. Cl. CPC E03B 1/044; F16K 11/02; E03B 2001/047

(57) ABSTRACT

A downspout diverter for rainwater collection that consists of a rotating diverter unit with a catchment gate that captures and redirects the flow of water to the outside of the downspout when it is turned to its horizontal upright position, and restores downflow when it is turned to its vertical open position. The device is easy to install and remove without disconnecting the downspout, and the small size of its port and fixtures effects a finished appearance to the downspout.

### TECHNICAL FIELD

The present invention is an apparatus that can be installed in a gutter downspout to divert rainwater for collection and storage using a gate-valve mechanism.

### BACKGROUND OF THE ART

Climate change and drought conditions in world temperate ones are likely to lead to an increased demand for water catchment and storage. Most jurisdictions in the United States allow residential water catchment for the harvest of non-potable water. For example, California's “Rainwater Capture Act of 2012” [2012 Cal. Stats. ch. 537. Sec. 2.] exempts the capture and use of rainwater from rooftops from the State Water Resources Control Board's (SWRCB) permitting authority over appropriations of water. According to the Board, “This development affords residential users and private and public entities with a new source of on-site water supply, which should reduce reliance on potable water for landscaping needs and provide a recharge benefit to underlying groundwater aquifers”. Rain barrels and on-site water storage systems have become popular, and the gutter and downspout systems of dwellings and small buildings can be retrofitted to divert rainwater into storage tanks. Currently available downspout diverters are difficult to install, and usually require disconnecting or defacing the downspout. Griffin, U.S. Pat. No. 8,739,817 B2, discloses a diverter and lid assembly for use with a rain barrel system. It has a central scoop installed in the downspout, however it is not adjustable and requires a 2⅛″ hole for installation. The resulting port can be covered with a large cap that must be attached with screws to the downspout. Soo Hean Teo, U.S. Pat. No. 8,517,047 B2, describes a gate that swings in and out of the downspout through an exterior housing. Harms, U.S. Pat. No. 3,990,474 A, describes a gate formed by the wall of the downspout that has no hose attachment. Others disclose a variety of devices with housings, pipes and attachments to divert water, but none describe an internal rotating catchment gate as disclosed in this application.

### DISCLOSURE OF INVENTION

The invention diverts water from a downspout, through a rotating side spout. It is easy to install and remove with minimal defacement of the downspout. It consists of a Wall Bushing seated in the face of the downspout, and a rotating Diverter Unit with a pan-like catchment gate spanning most of the inside the downspout (FIG. 1). When turned horizontally in a pan-up position (FIG. 4), the gate captures water flowing in the downspout and channels it through the central bore of the cylindrical body and hose attachment spout (FIG. 3). The Wall Bushing forms a permanent port in the face of the downspout for seating and rotation of the Diverter Unit; and, when the unit is removed, it can be sealed with a Threaded Plug (FIG. 7), effecting a trim appearance to the downspout.

### BRIEF DESCRIPTION OF THE DRAWINGS

FIG. 1—Perspective of the assembled invention.

FIG. 2—Perspective (isometric) of exploded parts.

FIG. 3—Vertical cross section taken on 3-3 of FIG. 1 with everything assembled.

FIG. 4—Top plan view of the installed device with Diverter Unit in the capture position.

FIG. 5—Top plan view of the installed device with Diverter Unit in the non-capture position.

FIG. 6—Left side view of the installed device with Diverter Unit and Threaded cap, in the non-capture position.

FIG. 7—Perspective (isometric) view of Wall Bushing and Threaded Plug

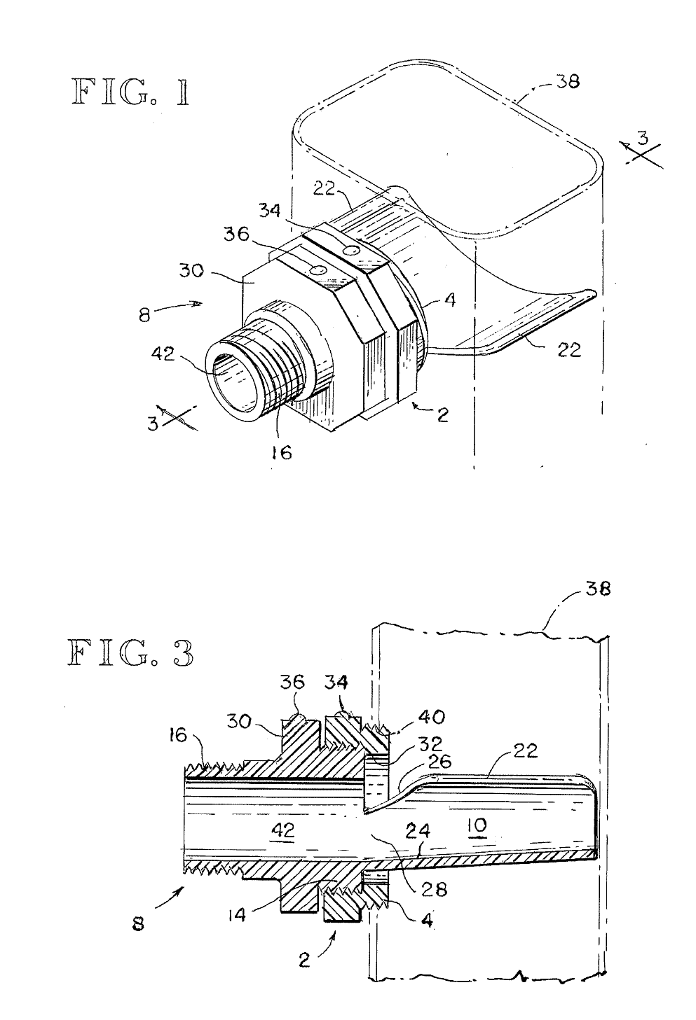

### BEST MODE FOR CARRYING OUT THE INVENTION

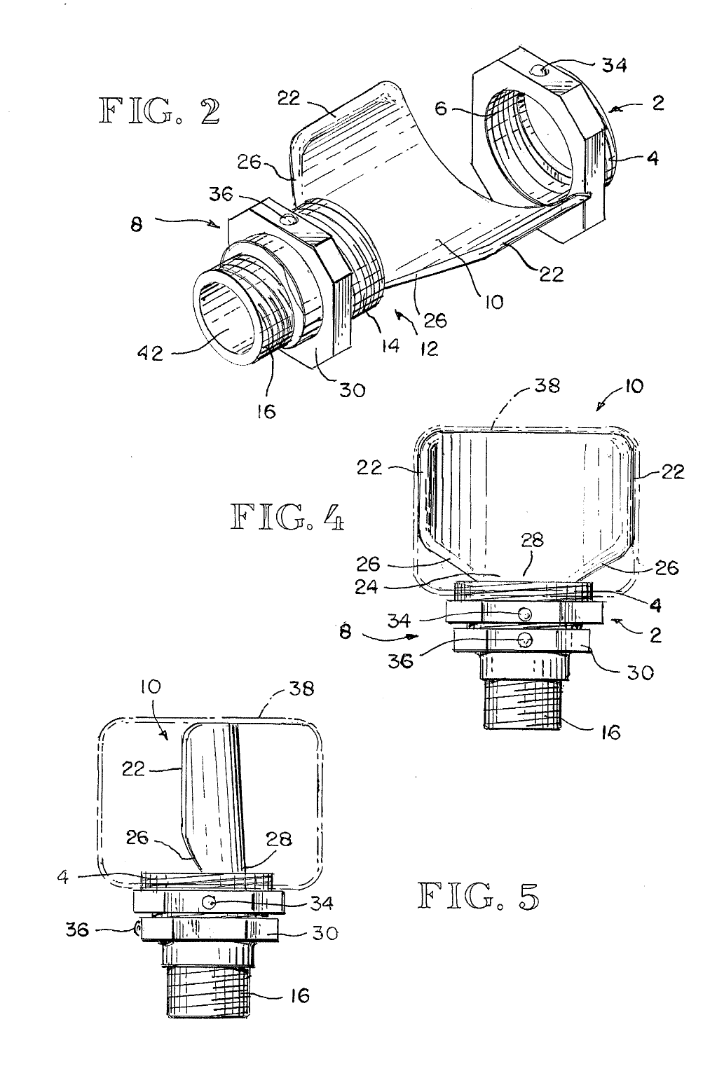

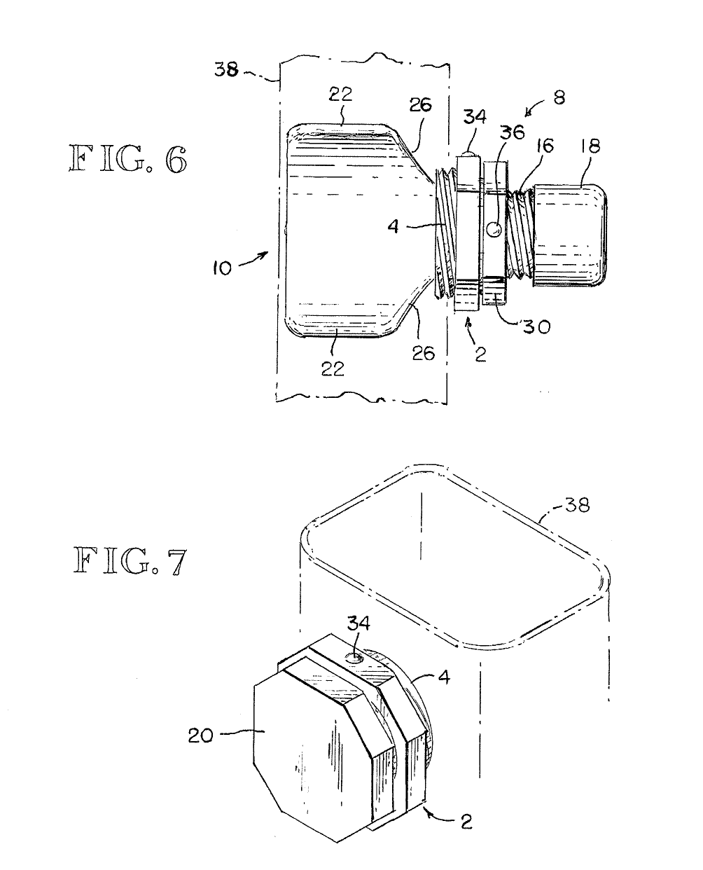

The preferred form of the device has four parts; a Wall Bushing 2 (FIG. 2), a Diverter Unit 8 (FIG. 2), a Threaded Cap 18 (FIG. 6), and a Threaded Plug 20 (FIG. 7). The Wall Bushing 2 is a plastic reduction bushing with a threaded male nipple 4 and threaded female port 6. It is installed by cutting a round hole in the face of the downspout and threading the nipple 4 clockwise into the hole. Once installed, it forms a permanent port for installation and removal of the Diverter Unit 8, and provides a threaded bearing for its seating and rotation. The Diverter Unit 8 is a single part formed of plastic. It consists of a pan-like catchment gate 10 that captures water within the downspout 38, a cylindrical body 12 with a threaded male nipple 14 that can be screwed into the female port 6 of the Wall Bushing 2, and a hose attachment spout 16 for water egress. Once installed, the Diverter Unit can be manually rotated to its marked capture position (FIG. 4) and non-capture position (FIG. 5) by grasping and rotating the body 12 clockwise or counter-clockwise. The Threaded Cap 18 is used to seal the spout 16 when a hose is not attached (FIG. 6), and the Threaded Plug 20 is used to seal the port 6 when the unit 8 is removed, leaving a trim appearance to the downspout (FIG. 7). The device can be manufactured as a built-in component of the downspout, and unlike other diverters, can be retrofitted in place without detaching the downspout from the building.

The catchment gate portion of the Diverter Unit 8 has a broad paddle-shaped pan 10 with tilted flanges 22 along its distal rim, and is shaped to capture most of the water flowing in the downspout 38. It has a thickened stem 24 that provides axial rigidity, and a tapered base 26 and thin expanse 28 that provides radial flexibility. Its sides 22 are coiled manually for insertion through the port 6, and because of the tapered base, they coil automatically when withdrawn through the port. When installed in its horizontal capture position, the gate 10 channels water into the central bore 42 of the body and spout. When turned 90 degrees counter-clockwise to its vertical position, it no longer captures water, and flow in the downspout 38 is restored. Its shape is non-occlusive and permits overflow during a heavy rain. And, normal downflow can easily be restored by rotating or removing the unit 8.

The Wall Bushing 2 is a ring-shaped reducing bushing made of hard plastic, fitted to accept the Diverter Unit. It has a hex surround 30 for installation with a wrench, and a smooth bore to permit insertion and withdrawal of the gate 10. Its threaded female port 6 accepts the threaded male nipple 14 on the body of the Diverter Unit, and has an internal stop wall 32 that limits advancement of the unit to its gate-up capture position. Both the Wall Bushing 2 and the body 8 have top markers 34 and 36 that, when aligned, confirm that the gate 10 is closed and ready to capture water. To switch to the non-capture position, the unit 8 is simply rotated 90 degrees counter-clockwise. The marker 36, now pointed to the left, shows that the gate 10 is in the vertical or open position.

Residential downspouts are commonly made from steel, aluminum or vinyl, formed in rectangular tubes, 2″×3″ in cross section; or, in cylindrical tubes 3″ in diameter. Larger models are made for larger roofs and gutter systems. Older models of rectangular downspouts have flat walls. Most current models are corrugated and semi-rounded. The face wall of a common 3 inch wide corrugated rectangular downspout maximally accommodates a 2⅛″ hole, cut perpendicularly through its side wall. Likewise, the wall of a 3″ cylindrical downspout can be cut to accommodate insertion of a threaded wall bushing, but the depth for full insertion is proportionate to the diameter of the bushing; hence a smaller diameter bushing results in a lesser intrusion into the downspout.

This device mounts through a 1½″ hole and fits in standard rectangular and cylindrical downspouts, as described. The spout is sized for the attachment of a ¾″ garden hose, however larger devices can be formed for larger downspouts and fitted for larger hoses and systems as desired.

For installation in a standard 2″×3″ flat or corrugated downspout, a round 1½″ hole is cut in the face of the downspout using a precision hole saw. The Wall Bushing 2 is threaded clockwise into the hole, using a wrench on the hex surround if necessary, until it firmly seats with its marker 34 pointed upward. The sides 22 of the gate 10 portion of the Diverter Unit 8 are manually rolled into a rounded coil and the gate 10 is passed into the lumen of the downspout through the Wall Bushing 6. The body of the Diverter Unit 8 is threaded clockwise into the Wall Bushing 2 until it comes to a firm top against the stop wall 32, with top markers 34 and 36 aligned. Once installed, the gate 10 rebounds into its pan-like shape and the device is ready to divert water into a hose and storage tank.

For removal, the Diverter Unit 8 is unthreaded counter-clockwise from the Wall Bushing 2 and firmly pulled from the downspout. The tapered edges 26 of the gate 10 force the gate to coil as it is withdrawn. The Threaded Plug 20 is installed in the port 6, and the Diverter Unit 8 can be saved for repeated use.

The unique advantages of the Gate Valve Downspout Diverter as described are: its ease of installation without disconnecting and sectioning the downspout; its ease of opening and closing to adjust water capture conditions; its ease of removal for cleaning and seasonal use; and, the small size of its port and fixtures that effect a finished appearance to the downspout.

1. A downspout diverter with a catchment gate that can be positioned horizontally to capture and redirect water through an alternative port in the downspout, or turned vertically to reopen the lumen of the downspout.

2. The diverter in claim 1in which the catchment gate channels water into an attached cylindrical body that can be used to rotate the gate to its capture and non-capture positions.

3. The diverter in claim 2 in which the body has a threaded nipple that can be screwed into a reducer bushing mounted in the wall of the downspout.

4. The diverter in claim 3 in which the diverter unit has a hose attachment spout at its proximal end.

5. The diverter in claim 4 in which the catchment gate, cylindrical body and hose attachment spout are formed as a single diverter unit that captures water in its gate and channels it through the central bore of its body and spout.

6. The diverter in claim 5 in which the catchment gate consists of a flexible plastic material formed into a broad pan to capture water when it is turned to its upright position.

7. The diverter in claim 6 in which the reducer bushing is installed in an existing downspout by cutting a round hole in the face of the downspout and screwing it securely into its wall.

8. The diverter in claim 7 in which the diverter unit is installed by rolling its gate portion into a rounded coil and inserting it through the port in the reducer bushing into the lumen of the downspout, and by screwing the male threads of its body portion into the female threads of the wall bushing.

9. The diverter in claim 8 in which both the wall bushing and the body portion of the diverter unit have hex surrounds with top markers to indicate their relative positions and show whether the gate is opened or closed.

10. The diverter in claim 9 in which the device can be sized for a ¾″ garden hose, or for larger downspouts and connections as desired.

11. The diverter in claim 10 in which the wall bushing is maintained as a permanent port for seating and removal of the diverter unit.

12. The diverter in claim 11 in which the gate portion has thin expanse with a tapered stem connected to its body portion to allow it to be rolled into a coil for insertion and removal from the downspout.

13. The diverter in claim 12 in which the port in the wall bushing can be sealed with a fitted plug when not in use.

14. The diverter in claim 7 in which the hole is less than two thirds the width of the downspout.
